(19) United States
(12) Patent Application Publication
(10) Pub. No.: US 2007/0156552 A1
(43) Pub. Date: Jul. 5, 2007

(54) Method and system for debt management

(76) Inventor: Anthony M. Manganiello, Prairie Du Chien, WI (US)

Correspondence Address: MCDERMOTT, WILL & EMERY LLP, 227 WEST MONROE STREET, CHICAGO, IL, 60606-5096, US

(21) Appl. No.: 11/545,171

(22) Filed: Oct. 10, 2006

Related U.S. Application Data
(60) Provisional application No. 60/725,233, filed on Oct. 11, 2005.

(51) Int. Cl. G06Q 40/00

(52) U.S. Cl. 705/35

(57) ABSTRACT

A system and method for debt management is provided, comprising logic for receiving financial information, wherein the financial information comprises debt information. The system further comprises logic for generating a debt impact analysis based on the financial information, and logic for generating a first debt management proposal by analyzing a first impact of the first proposal on the financial information. The system further comprises logic for generating a second debt management proposal by analyzing a second impact of the second proposal on the financial information, and logic for comparing the first and second debt management proposals. The system further comprises logic for generating a user interface comprising one of the first and second debt management proposals, based on the comparison of the first and second proposals.

### TECHNICAL FIELD

The invention relates to a method and system for debt management, and more particularly, to electronically analyzing data and determining appropriate debt consolidation and/or elimination solutions.

### BACKGROUND OF THE INVENTION

Many companies offer financial debt consolidation and/or elimination solutions. Generally, these companies gather financial information from a consumer and use that information to determine whether the consumer qualifies for a debt consolidation and/or elimination program offered by that company. However, that process is limited to conforming the consumer's financial situation to the product or service that the institution has available.

For example, a mortgage company collects limited data for qualifying a consumer for a lending product provided by that mortgage company. The consumer data is collected and screened only with regards to offering the consumer a loan, and typically no other viable recommendations are made. In the case of a consumer credit counseling service, the consumer's budget is reviewed to determine the need and likelihood of the consumer subsidizing the program. Alternatively, in the case of a debt settlement company, the consumer's budget is reviewed, but competitor debt consolidation programs generally are not recommended. Thus, in general, financial institutions do not provide financial analysis based on all factors and options; rather, such institutions typically only consider factors in their own best interest. A need therefore exists for a system and method designed to offer multiple debt consolidation products and services and to determine when various products are available.

The present invention is provided to solve the problems discussed above and other problems, and to provide advantages and aspects not provided by prior debt consolidation products and services of this type. A full discussion of the features and advantages of the present invention is deferred to the following detailed description, which proceeds with reference to the accompanying drawings.

### SUMMARY OF THE INVENTION

The present invention provides an executable system for managing debt, wherein the system resides in a memory and comprises logic for receiving financial information, wherein the financial information comprises debt information. The system further comprises logic for generating a debt impact analysis based on the received financial information. Also comprised by the system is logic for generating a first debt management proposal by analyzing a first debt management solution impact on the received financial information. The system further comprises logic for generating a second debt management proposal by analyzing a second debt management solution impact on the received financial information. The system also has logic for comparing the first and second debt management proposals, and logic for generating a user interface, wherein the interface comprises one of the first and second debt management proposals based on the comparison of the proposals.

In one embodiment, the debt impact analysis includes a base accelerator margin potential value. In another embodiment, at least one of the first and second debt management proposals is based on the base accelerator margin potential value. In a further embodiment, the financial information comprises income information, housing information, living expensive information, insurance information, liquid asset information, retirement asset information and/or hardship information. In yet another embodiment, the system further comprises logic for receiving applicant information.

In one embodiment, the debt information includes negotiable debt information and/or non-negotiable debt information. In another embodiment, the first and/or second debt management solutions is a consumer software product, an automated debt payment system, a lending product for restructuring debt, a consumer credit counseling program, a debt settlement legal service and/or a bankruptcy service. In a further embodiment, the debt impact analysis includes a cash position statement, an amount of debt service payments applied to principal and interest, a timeline for settling an individual debt and/or a statement of potential impact of cash flow on a credit report.

The present invention further provides a system for managing debt comprising a first code segment for receiving financial information, wherein the financial information comprises debt information. The system further comprises a second code segment for generating a debt impact analysis based on the financial information, and a third code segment for generating a base accelerator margin potential based on the financial information. The system also comprises a fourth code segment for comparing the base accelerator margin potential value with an accelerator base margin value for a first debt management solution, and a fifth code segment for recommending the first debt management solution if the base accelerator margin value is greater than the accelerator base margin value for the first debt management solution.

In one embodiment, the system further comprises a sixth code segment for comparing the base accelerator margin potential value with an accelerator base margin value for a second debt management solution, and a seventh code segment for recommending the second debt management solution if the base accelerator margin value is greater than the accelerator base margin value for the second debt management solution.

The present invention further provides a method for recommending a debt management solution, comprising the step of receiving financial information from a user via a computer-generated user interface, wherein the financial information comprises at least debt information. The method further comprises the steps of generating a base accelerator margin value based on the financial information, and analyzing a first debt management solution by comparing the base accelerator margin value with a first solution margin value corresponding to the first debt management solution. The method also comprises the step of analyzing a second debt management solution by comparing the base accelerator margin value with a second solution margin value corresponding to the second debt management solution. The method further comprising the steps of selecting a selected debt management solution from among the first and second debt management solutions based on the first and second solution margin values, and generating a user interface comprising the selected debt management solution.

According to the present invention, a computer program for consolidating debt for the purposes of debt elimination is provided. The computer program comprises logic for receiving financial information including debt information, logic for generating a debt impact analysis based on the received financial information and, logic for generating a debt consolidation and/or elimination solution based on the received financial information. Further, the computer program comprises logic for receiving applicant information.

According to another aspect of the invention, the financial information comprises at least one of income information, housing information, living expense information, insurance information, liquid asset information, retirement asset information, hardship information, and additional considerations. Further, the debt information includes at least one of negotiable debt information and non-negotiable debt information. In addition the debt impact analysis includes at least one of a cash position statement, an amount of debt service payments applied to principal and interest, a timeline for an individual debt to be paid off, and a statement of potential impact of cash flow on a credit report.

According to yet another aspect of the invention, the debt consolidation solution includes at least one of a Do-It-Yourself software product, an automated debt payment system, a lending product for restructuring debt, a consumer credit counseling, a debt settlement legal service, and a bankruptcy service.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of a computer used in connection with the present invention;

FIG. 2 is a flow chart illustrating one embodiment of the method for determining an optimal debt consolidation solution in accordance with present invention;

FIG. 3 is an illustration of a graphical user interface comprising a portal for accessing a system for debt management;

FIG. 4 is an illustration of a graphical user interface comprising a plurality of entry forms for providing information to a system for debt management;

FIG. 5 is an illustration of a graphical user interface comprising visual fields for providing income information to a system for debt management;

FIG. 6 is an illustration of a graphical user interface comprising visual fields for providing housing information to a system for debt management;

FIG. 7 is an illustration of a graphical user interface comprising visual fields for providing living expense information to a system for debt management;

FIG. 8 is an illustration of a graphical user interface comprising visual fields for providing insurance information to a system for debt management;

FIG. 9 is an illustration of a graphical user interface comprising visual fields for providing asset information to a system for debt management;

FIG. 10 is an illustration of a graphical user interface comprising visual fields for providing additional financial consideration information to a system for debt management;

FIG. 11 is an illustration of a graphical user interface comprising visual fields for providing financial hardship and financial goal information to a system for debt management;

FIG. 12 is an illustration of a graphical user interface comprising visual fields for providing non-negotiable debt information to a system for debt management;

FIG. 13 is an illustration of a graphical user interface comprising visual fields for providing negotiable debt information to a system for debt management;

FIG. 14 is an illustration of a graphical user interface comprising visual fields for displaying debt summary information for use with the present system for debt management;

FIG. 15 is an illustration of a graphical user interface comprising visual fields for displaying information comprising a debt impact analysis, for use with the present system for debt management; and,

FIG. 16 is an illustration of a graphical user interface comprising visual fields for displaying information comprising a debt impact analysis, for use with the present system for debt management.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The system and method of the present invention is configured to determine debt consolidation solutions by analyzing a consumer's budget, including assets, liabilities and cash flow position. The system and method employed in connection with the present invention also assists in providing that all appropriate recommendations regarding debt consolidation are presented to the consumer.

The process descriptions or blocks shown in the figures of the various embodiments discussed should be understood as representing modules, segments, or portions of code which include one or more executable instructions for implementing specific logical functions or steps in the process. Alternate implementations are included within the scope of the various embodiments in which functions may be executed out of order from that shown or discussed, including substantially concurrently or in reverse order, depending on the functionality involved, as would be understood by those having ordinary skill in the art.

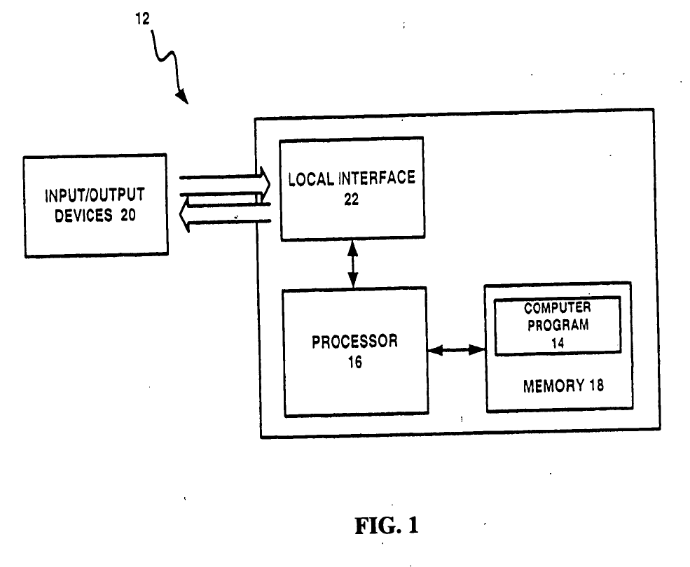

FIG. 1 is a block diagram of a computer or server 12. For purposes of understanding the hardware as described herein, the terms “computer” and “server” have identical meanings and are interchangeably used. The computer 12 includes a cash flow analysis system 14. The cash flow analysis system 14 of the invention can be implemented in software (e.g., firmware), hardware, or a combination thereof. In the currently contemplated best mode, the cash flow analysis system 14 is implemented in software, as an executable program, and is executed by one or more special or general purpose digital computer(s), such as a personal computer (PC; IBM-compatible, Apple-compatible, or otherwise), personal digital assistant, workstation, minicomputer, or mainframe computer. An example of a general purpose computer that can implement the cash flow analysis system 14 of the present invention is shown in FIG. 1. The cash flow analysis system 14 may reside in, or have portions residing in, any computer such as, but not limited to, a general purpose personal computer. Therefore, the computer 12 of FIG. 1 may be representative of any computer in which the cash flow analysis system 14 resides or partially resides.

Generally, in terms of hardware architecture, as shown in FIG. 1, the computer 12 includes a processor 16, memory 18, and one or more enter and/or output (I/O) devices 20 (or peripherals) that are communicatively coupled via a local interface 22. The local interface 22 can be, for example, but not limited to, one or more buses or other wired or wireless connections, as is known in the art. The local interface 22 may have additional elements, which are omitted for simplicity, such as controllers, buffers (caches), drivers, repeaters, and receivers, to enable communications. Further, the local interface may include address, control, and/or data connections to enable appropriate communications among the other computer components.

The processor 16 is a hardware device for executing software, particularly software stored in memory 18. The processor 16 can be any custom made or commercially available processor, a central processing unit (CPU), an auxiliary processor among several processors associated with the computer 12, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x8 or Pentium series microprocessor from Intel Corporation, a PowerPC microprocessor from IBM, a Sparc microprocessor from Sun Microsystems, Inc., or a 8xxx series microprocessor from Motorola Corporation.

The memory 18 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 18 may incorporate electronic, magnetic, optical, and/or other types of storage media. The memory 18 can have a distributed architecture where various components are situated remote from one another, but can be accessed by the processor 16.

The software in memory 18 may include one or more separate programs, each of which comprises an ordered listing of executable instructions for implementing logical functions. In the example of FIG. 1, the software in the memory 18 includes the cash flow analysis system 14 in accordance with the present invention and a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). The operating system essentially controls the execution of other computer programs, such as the cash flow analysis system 14, and provides scheduling, enter-output control, file and data management, memory management, and communication control and related services.

The cash flow analysis system 14 may be a source program, executable program (object code), script, or any other entity comprising a set of instructions to be performed. When a source program, the program needs to be translated via a compiler, assembler, interpreter, or the like, which may or may not be included within the memory 18, so as to operate properly in connection with the O/S. Furthermore, the cash flow analysis system 14 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada. In one embodiment, the cash flow analysis system 14 is written in C++. The I/O devices 20 may include enter devices, for example but not limited to, a keyboard, mouse, scanner, microphone, touch screens, interfaces for various medical devices, bar code readers, stylus, laser readers, radio-frequency device readers, etc. Furthermore, the I/O devices 20 may also include output devices, for example but not limited to, a printer, bar code printers, displays, etc. Finally, the I/O devices 20 may further include devices that communicate both enters and outputs, for instance but not limited to, a modulator/demodulator (modem; for accessing another device, system, or network), a radio frequency (RF) or other transceiver, a telephonic interface, a bridge, a router, etc.

If the computer 12 is a PC, workstation, PDA, or the like, the software in the memory 18 may further include a basic enter output system (BIOS) (not shown in FIG. 1). The BIOS is a set of software routines that initialize and test hardware at startup, start the O/S, and support the transfer of data among the hardware devices. The BIOS is stored in ROM so that the BIOS can be executed when the computer 12 is activated.

When the computer 12 is in operation, the processor 16 is configured to execute software stored within the memory 18, to communicate data to and from the memory 18, and to generally control operations of the computer 12 pursuant to the software. The cash flow analysis system 14 and the O/S, in whole or in part, but typically the latter, are read by the processor 16, perhaps buffered within the processor 16, and then executed.

When the cash flow analysis system 14 is implemented in software, as is shown in FIG. 1, it should be noted that the cash flow analysis system 14 can be stored on any computer readable medium for use by or in connection with any computer related system or method. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). The cash flow analysis system 14 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In another embodiment, where the cash flow analysis system 14 is implemented in hardware, the cash flow analysis system 14 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

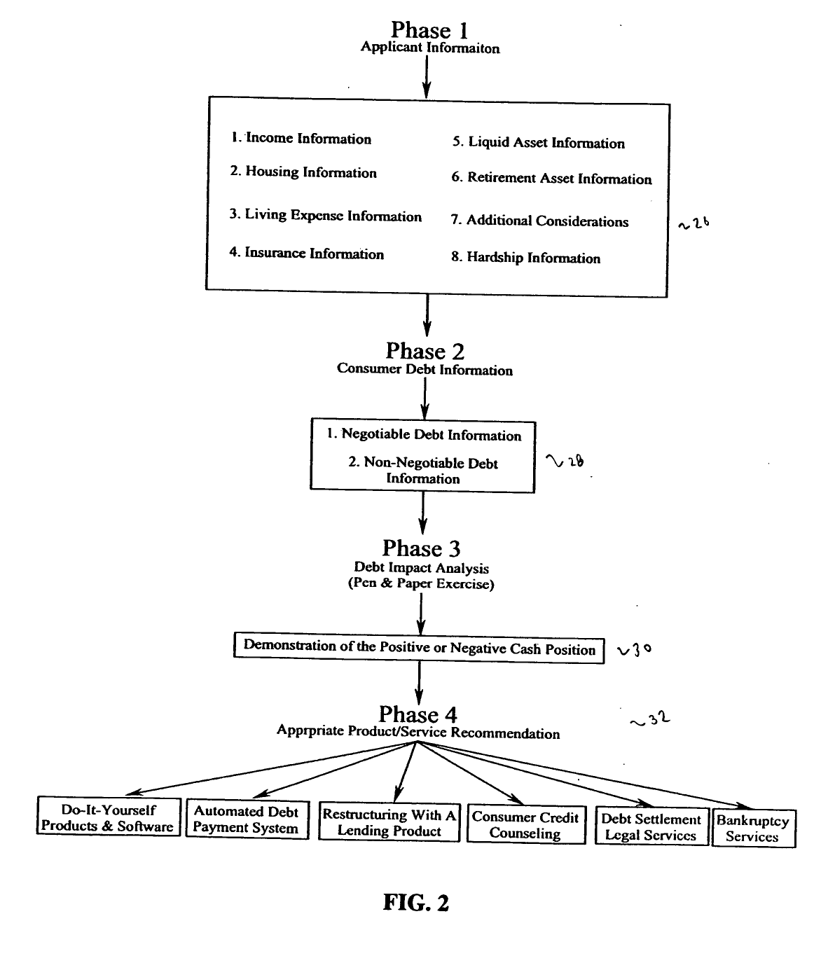

FIG. 2 illustrates a general flow of one embodiment of the method for debt management, specifically by determining the optimal debt consolidation solution for a user according to the present invention. As shown, applicant information and financial data 26 are provided to the system 14. The financial data 26 can include income information, housing information, living expense information, insurance information, liquid asset information, retirement asset information, hardship information and additional considerations. In addition, current and delinquent debt data 28 is provided to the system 14. In a preferred embodiment, the debt data 28 is characterized as either non-negotiable debt and/or negotiable debt.

Once the applicant information, financial data 26 and debt data 28 are provided, the system 14 provides a debt impact analysis based on an analysis of the provided financial data 26 and provided debt data 28. The debt impact analysis 30 first provides information such as cash position, including the amount of debt service payments applied to principal and interest, timelines for each individual debt to be paid off, and potential impact of the consumer's cash flow on the consumer's credit report. After the cash position is provided and/or illustrated to the consumer user, the present invention proceeds to provide the appropriate debt consolidation product or service recommendation.

A user of the cash flow analysis system 14 described above interacts with the system 14 via a unique graphical user interface (“GUI”). The GUI enables the user to navigate through the system 14 to enter applicant information, financial data 26 and debt data 28 to provide the debt impact analysis 30 and provide the appropriate debt consolidation product or service recommendation. The GUI can be part of a software program residing in whole or in part in a computer 12, or it may reside in whole or in part on a server coupled to a computer 12 via a network connection, such as through the Internet or a local or wide area network (LAN or WAN). Moreover, a wireless connection can be used to link to the network.

In a preferred embodiment, the system 14 is accessed via local area network connection from a computer 12. It will be appreciated by one of skill in the art that a web browser computer program can be used on the computer 12 to access a server hosting the system program. In that embodiment, the GUI for the system 14 will appear via the web browser software as locally run program on the display of the computer 12.

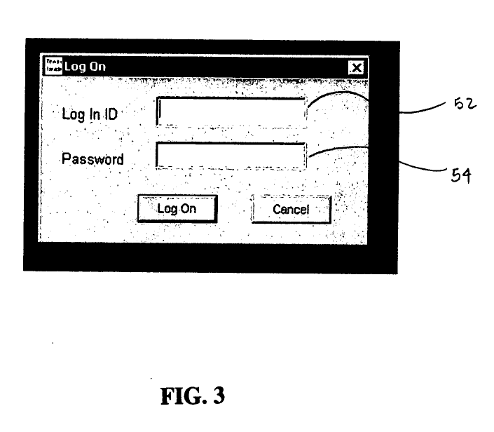

As shown in FIG. 3, the GUI initially provides the user with a portal or “Log On” page 50 that provides fields for enter of a user name 52 and password 54 to gain access to the system. Additionally, the GUI can direct a user to one or more pages for setting up a user name and password if one does not yet exist.

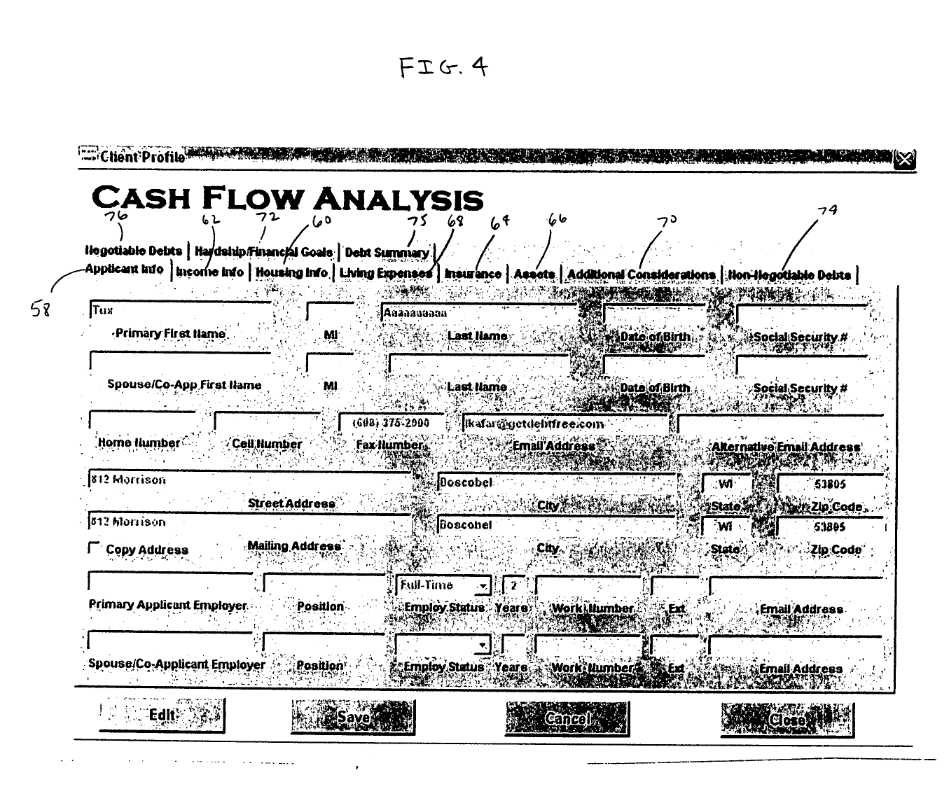

Referring to FIG. 4, once logged into the system 14, the user can navigate through the program by clicking one of the elements that visually appear as tabs generally on the upper portion of the display screen 56. In the embodiment shown in FIG. 4, the system 14 includes an Applicant Info tab 58, a Housing Info tab 60, an Income Info tab 62, an Insurance tab 64, an Assets tab 66, a Living Expenses tab 68, an Additional Considerations tab 70, a Hardship/Financial Goals tab 72, a Non-Negotiable Debt tab 74, a Negotiable Debts tab 76, and a debt summary tab 75. A variety of the other tabs with additional information can also be made available. It will be understood that the names and positioning of the tabs on the display screen 56 are variable, and that a variety of names and positions are practicable within the present invention, including displaying all of the tabs and visual display fields on a single page.

The computer program 14 associated with the present invention can be utilized to enter various types of information about a customer to facilitate a determination of debt consolidation solutions based on the entered information. Referring again to FIG. 4, the Applicant Info tab 58 enables the user to enter, modify, or view contact information. For example and as illustrated, the Applicant Info tab 58 includes visual fields for entering primary name and date of birth, spouse name and date of birth, phone numbers, address, and employer information.

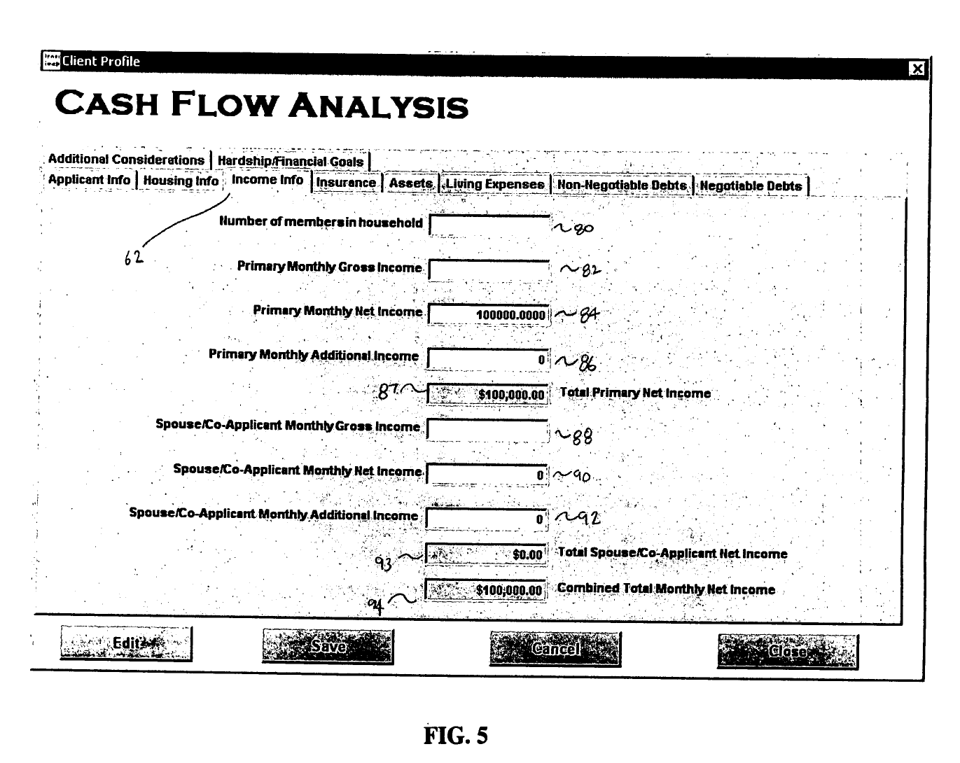

As illustrated in FIG. 5, the Income Info tab 62 enables a user to enter, modify, or view income information. The Income Info tab 62 includes a “Number of members in the household” visual field 80 for entering the number of all individuals currently residing in the home in which the customer resides. A “Primary Monthly Gross Income” visual field 82, a “Primary Monthly Net Income” visual field 84 and a “Primary Monthly Additional Income” visual field 86 are provided for entering the customer's income information. The system 14 calculates and displays the “Total Primary Net Income” in a visual field 87.

Additionally, a “Spouse/Co-Applicant Monthly Gross Income” visual field 88, a “Spouse/Co-Applicant Monthly Net Income” visual field 90 and a “Spouse/Co-Applicant Monthly Additional Income” visual field 92 are provided for entering the spouse or co-applicant's income information. The system 14 calculates and displays the “Total Spouse/Co-Applicant Monthly Net Income” in a visual field 93 and the “Combined Total Monthly Net Income” in a visual field 94.

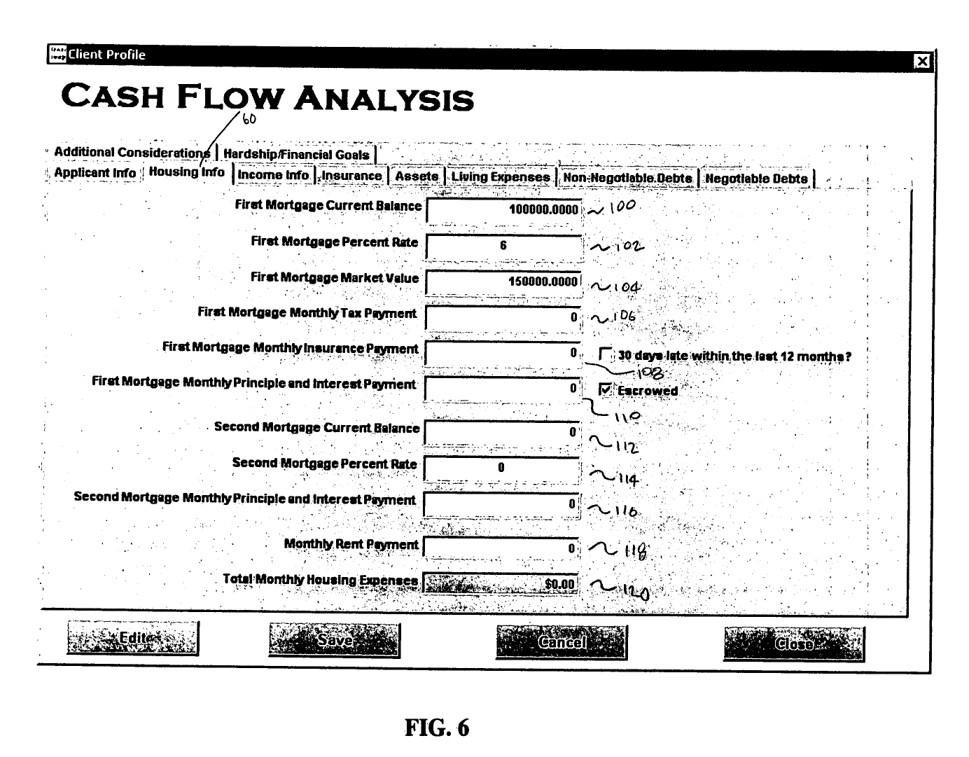

As illustrated in FIG. 6, the Housing Info tab 60 enables a user to enter, modify, or view housing information. The Housing Info tab 60 includes a “First Mortgage Current Balance” visual field 100 for entering the principle and interest amounts that remain to be paid on the primary loan for the residence in which the customer resides. A “First Mortgage Percent Rate” visual field 102 is provided for entering the percentage rate on the primary loan for the residence the customer resides in. Further, a “First Mortgage Market Value” visual field 104 is provided for entering the current appraisal value for the residence the customer resides in. The property tax and/or any other taxes that are paid on a monthly basis can be entered in the “First Mortgage Monthly Tax Payment” visual field 106. In addition, a “First Mortgage Monthly Insurance Payment” visual field 108 is provided for entering residential insurance monthly payments and a “First Mortgage Monthly Principle and Interest Payment” visual field 110 is provided for entering the monthly principle and interest payment paid for the residence in which the customer resides.

The Housing Info tab 60 further includes a “Second Mortgage Current Balance” visual field 112 for entering home equity loan information, a “Second Mortgage Percent Rate” visual field 114 for entering the percentage rate for the home equity loan and a “Second Mortgage Monthly Principle and Interest Payment” visual field 116 for entering the monthly principle and interest payment paid on the home equity loan. In addition, a “Monthly Rent” visual field 118 is provided for entering the amount, if any, the customer pays a property owner for renting the residence. The system 14 calculates and displays the “Total Monthly Housing Expense” in a visual field 120.

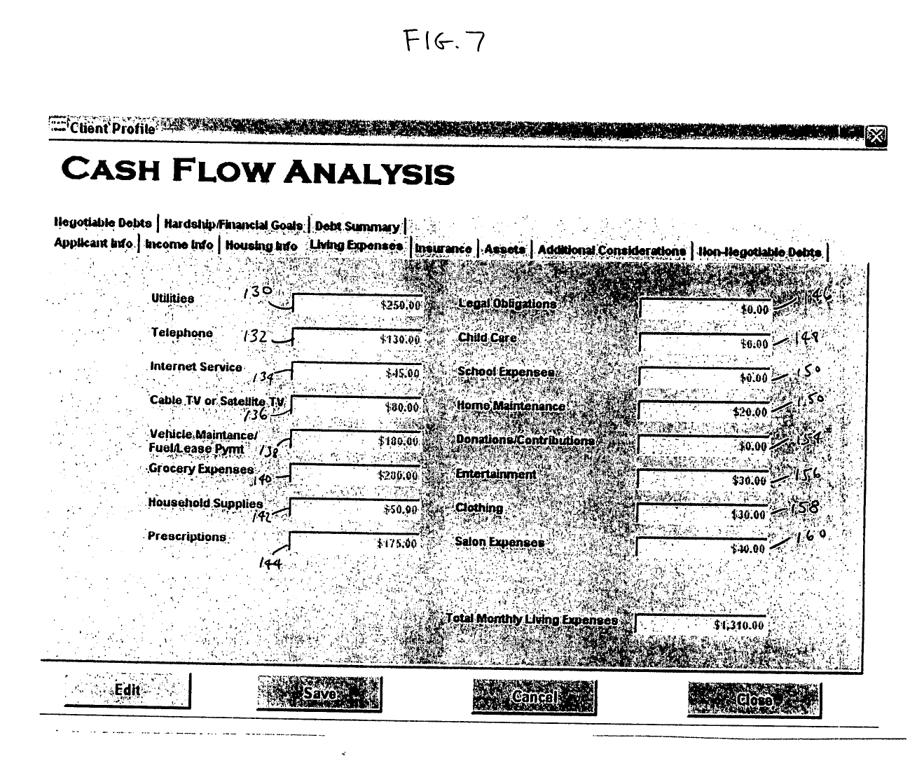

As illustrated in FIG. 7 the Living Expenses tab 60 enables a user to enter, modify or view living expenses information. The Living Expenses tab 60 includes a “Utilities” visual field 130, a “Telephone” visual field 132, an “Internet Service” visual field 134, a “Cable TV or Satellite TV” visual field 136, a “Vehicle Maintenance/Fuel” visual field 138, a “Grocery Expenses” visual field 140, a “Household Supplies” visual field 142, a “Prescriptions” visual field 144, a “Legal Obligations” visual field 146, a “Child Care” visual field 148, a “School Expenses” visual field 150, a “Home Maintenance” visual field 152, a “Donations/Contributions” visual field 154, an “Entertainment” visual field 156, a “Clothing” visual field 158 and a “Salon Expenses” visual field. Living expense information relating to the above-identified visual fields is entered into the respective visual field, to provide the system 14 with values corresponding to the living expenses of the customer.

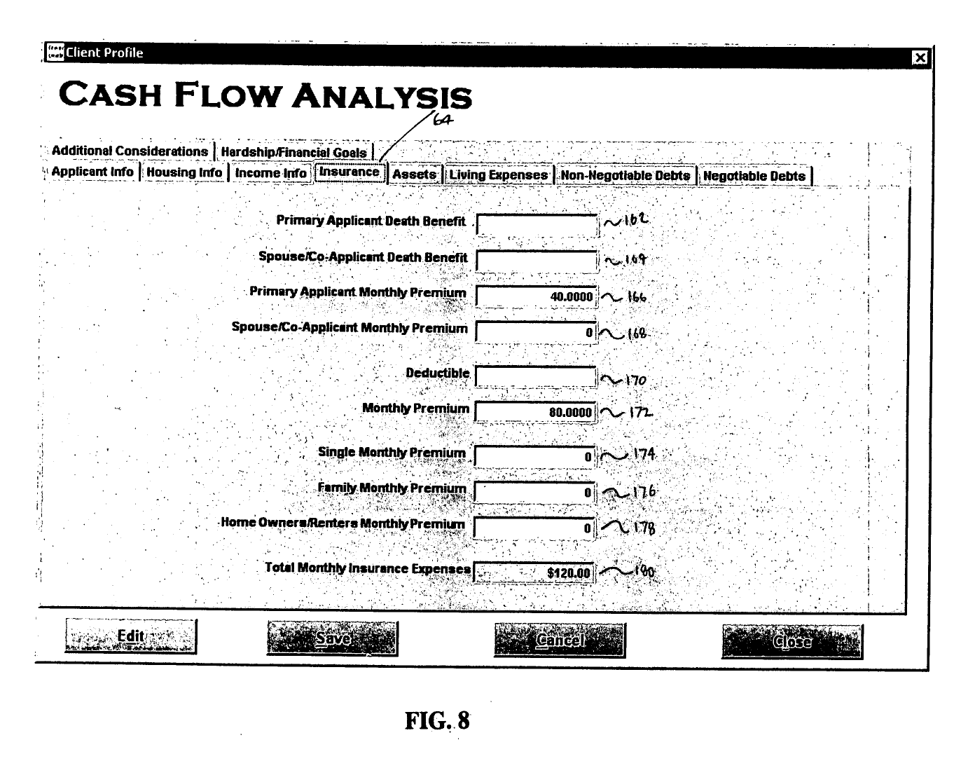

FIG. 8 illustrates the Insurance tab 64 which enables a user to enter, modify or view insurance information. The Insurance tab 64 includes a “Primary Applicant Death Benefit” visual field 162 for entering the amount of money paid upon the death of the customer. A “Spouse/Co-Applicant Death Benefit” visual field 164 is provided for entering the amount of money paid upon the death of the policyholder of a second policy. A “Primary Applicant Monthly Premium” visual field 166 and a “Spouse/Co-Applicant Monthly Premium” visual field 168 are provided for entering the amount of money paid monthly on the respective policies relating to death benefits. A “Deductible” visual field 170 is provided for entering the amount of money the customer is responsible for if the customer's vehicle is damaged or causes damage to another's property and a “Monthly Premium” visual field 172 is provided for entering the amount of money that is paid to the insurance company for monthly coverage for the automobile.

In addition, the Insurance tab 64 provides a “Single Monthly Premium” tab 174 for entering the amount of money paid out of pocket to an insurance company for medical, dental, vision and prescription drug coverage per month if the policy coverage is for a single person. If the policy is for a family plan, a “Family Monthly Premium” visual field 176 is provided for entering the amount of money paid for the same type of coverage as the single person plan. A “Home Owners/Renters Monthly Premium” visual field 178 is provided for entering the amount of money that is paid for insurance to coverage relating to fire, natural disasters, and any loss or damage to the property. The system 14 calculates and displays the “Total Monthly Insurance Expenses” in visual field 180.

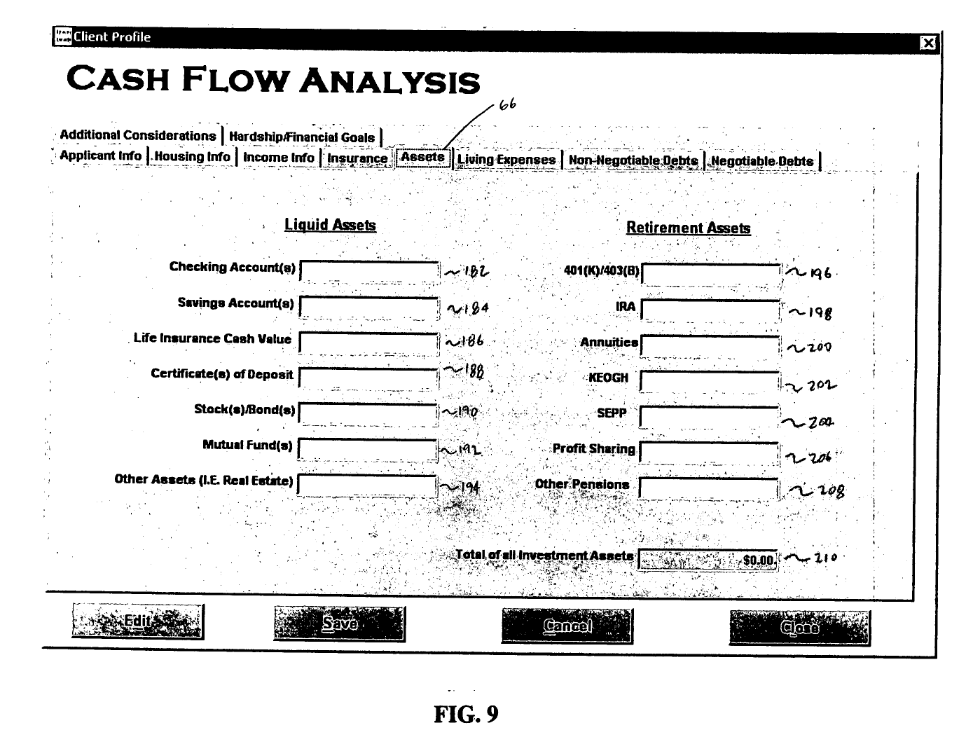

As illustrated in FIG. 9 the Assets tab 66 enables a user to enter, modify, or view asset information. The Assets tab 66 is separated into a Liquid Assets list and a Retirement Assets list. Liquid Assets include items of value that are readily available with no tax penalty or liability. The Liquid Assets list includes a “Checking Account” visual field 182 and “Savings Account” visual field 184 for entering the amount of money available from the respective accounts. A “Life Insurance Cash Value” visual field 186 is provided for entering the accrued cash value of a life insurance policy. In addition, a “Certificate of Deposit” visual field 188, a “Stock/Bond” visual field 190 and a “Mutual Fund” visual field 192 are provided for entering the amount of money in certificate of deposits, stocks/bonds and mutual funds, respectively. Finally, an “Other Assets” visual field 194 is provided for entering the value of any assets that are not included in the above-identified categories.

The Retirement Assets list includes assets which, typically, cannot be withdrawn until the customer reaches retirement age. The Retirement Assets include a “401(k)/403(B)” visual field 196 for entering the amount of money in a 401(k) or 403(B) account, or a similar tax-deferred account, and a “IRA” visual field 198 for entering the amount of money in a IRA account. An “Annuities” visual field 200 is provided for entering any annuity payments made by an insurance provider. In addition, a “KEOGH” visual field 202 and a “SEPP” visual field 204 are provided for entering the amount of money in a KEOGH account and a SEPP account, respectively. A “Profit Sharing” visual field 206 is provided for entering the amount of money in a profit sharing account and an “Other Pensions” visual field 208 is provided for entering any pension assets that are not included in the above-identified categories. The system 14 calculates and displays the “Total of all Investment Assets” in visual field 210.

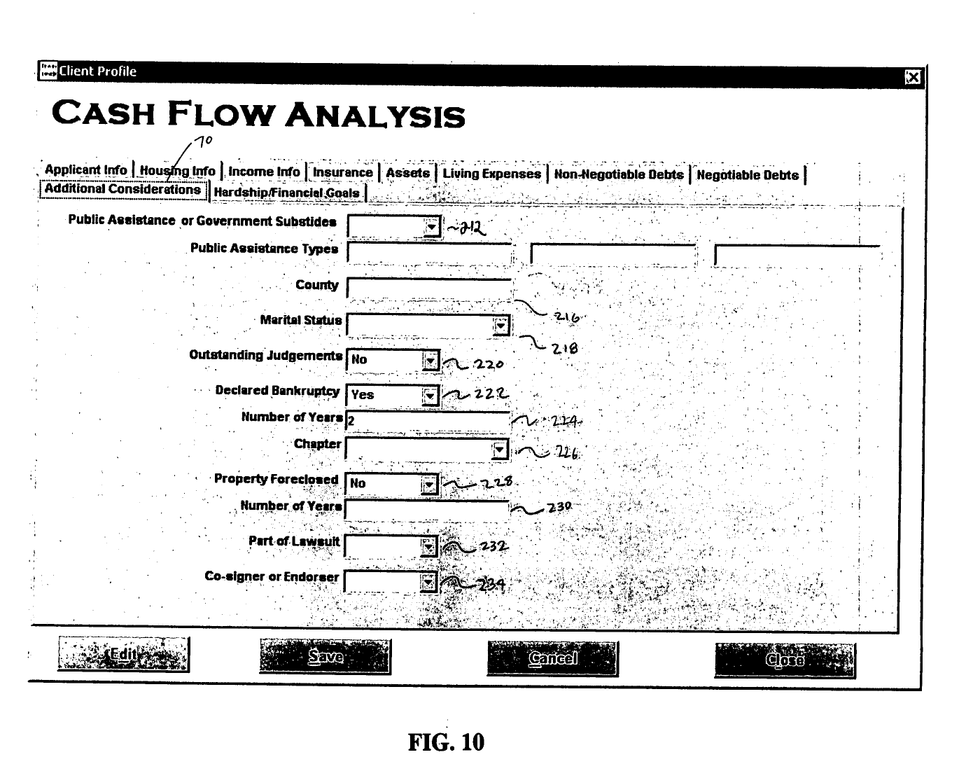

FIG. 10 illustrates the Additional Considerations tab 70 which enables a user to enter, modify, or view additional considerations. The Additional Considerations tab 70 includes several visual fields for entering relevant financial information not entered in other tabs. These visual fields include a “Public Assistance or Government Subsidies” visual field 212, “County Residence” visual field 216, a “Marital Status” visual field 218, an “Outstanding Judgments” visual field 220, a “Declared Bankruptcy” visual field 222, along with other visual fields 224, 226, 228, 230, 232, 234 related to the bankruptcy.

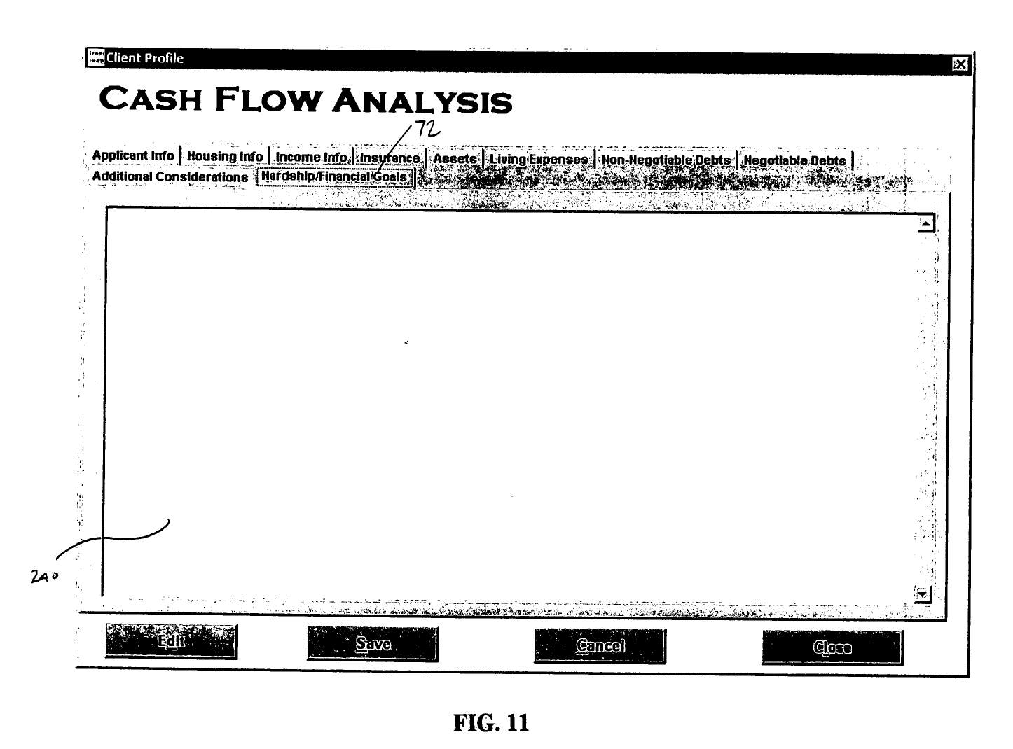

As illustrated in FIG. 11, the Hardship/Financial Goals tab 72 enables a user to enter, modify or view hardship and financial goal information. A visual field 240 is provided for the user to enter comments related to any hardships or financial goals that were not entered in any of the visual fields discussed above.

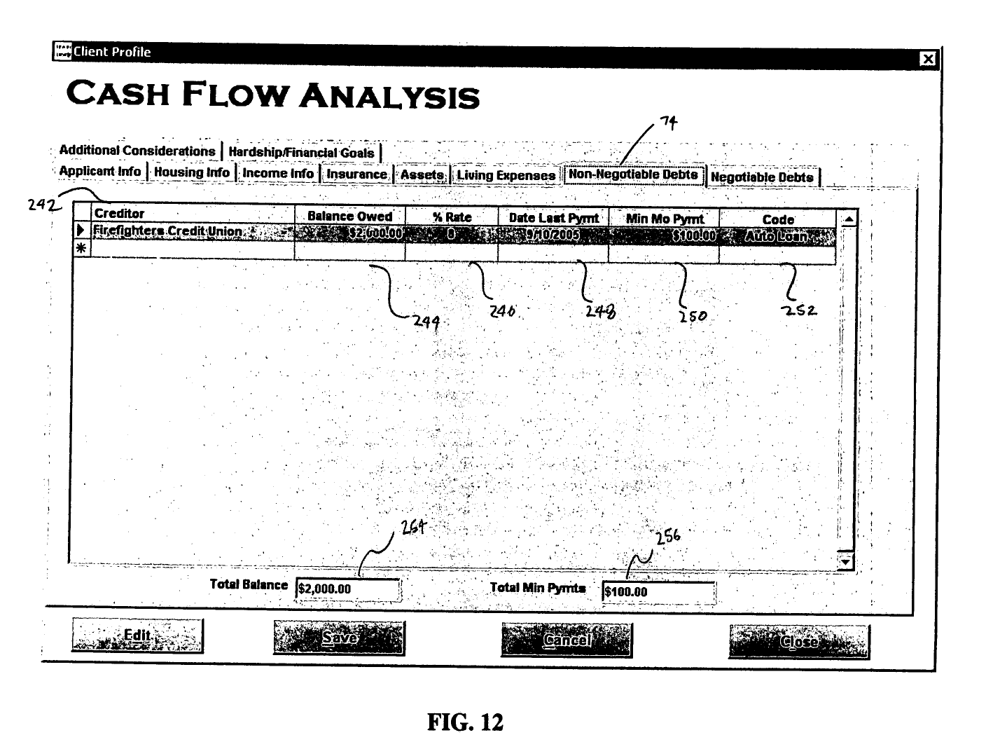

FIG. 12 illustrates the Non-Negotiable Debts tab 74 which enables a user to enter, modify or view non-negotiable debt information. The Non-Negotiable Debts tab 74 includes a “Creditor” visual field 242 for entering the name of the creditor or institution that made the loan. A “Balance Owed” visual field 244 is provided for entering the entire amount owed to the creditor and a “% Rate” visual field 246 is provided for entering the current percentage at which the debt is financed. In addition, a “Date of Last Payment” visual field 248 is provided for entering the date the last payment was made and a “Minimum Monthly Payment” visual field 250 is provided for entering the amount of money that the creditor expects the customer to pay on the debt. A “Code” visual field is provided for entering the type of the debt.

According to the preferred embodiment, the following codes signify the respective debt type:

TABLE 1

| Code | Type of Debt |
|---|---|
| AL | Auto loans, such as debts for a vehicle still in |
| | customer's possession. |
| OL | Other loans, such as old cell phone, telephone, |
| | or utilities bills that customer receives service |
| | through or plans to in the future. |
| PL | Personal loans, such as a debt to a family |
| | member or friend. |
| EL | Educational loans, such as a government |
| | student loan or payment plans to any |
| | educational institution. |
| SL | Secured loans, such as any debt with an |
| | institution or billing party held with collateral. |
| CU | Credit Union loans, such as any loan, credit |
| | card, or debt a federal credit union institution |
| | has backed. |
| BL | Business loans, such as any debt that is under |
| | a business name or used for business purposes. |
| TL | Tax liens, such as any state or federal tax lien. |
| CC | Credit card loans, such as any credit card debt |
| | that is business related, or has any relationship |
| | with the customer's current financial |
| | institution or employer. This can include any |
| | debt that is currently in any form of legal |
| | action or garnishment. |
| MB | Medical bills, such as any medical bill from a |
| | facility or doctor whose services the customer |
| | utilizes. |

The system 14 calculates and displays the “Total Balance” of all non-negotiable debt in a visual field 254 and calculates and displays the “Total Minimum Payments” for all the non-negotiable debt in a visual field 256.

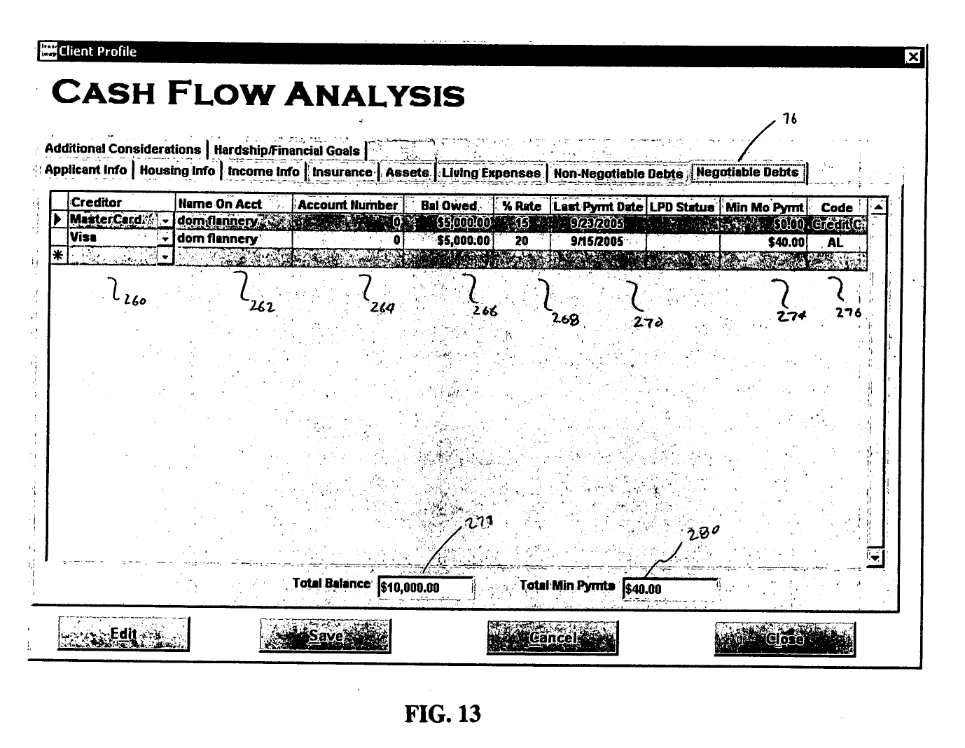

As illustrated in FIG. 13, the Negotiable Debt tab 76 enables a user to enter, modify or view negotiable debt information. The Negotiable Debt tab 76 includes a “Creditor” visual field 260 for entering the name of the creditor or institution that made the loan. A “Name” visual field 262 is provided for entering the name on the account and an “Account Number” visual field 264 is provided for entering the account number. Further, a “Balance Owed” visual field 266 is provided for entering the entire amount owed to the creditor and a “% Rate” visual field 268 is provided for entering the current percentage at which the debt is financed. In addition, a “Date of Last Payment” visual field 270 is provided for entering the date the last payment was made and a “Minimum Monthly Payment” visual field 274 is provided for entering the amount of money that the creditor expects the customer to pay on the debt. A “Code” visual field is provided for entering the type of the debt.

According to the preferably embodiment, the following codes signify the respective debt type:

TABLE 2

| Code | Type of Debt |
|---|---|
| AL | Auto loans, such as the remaining balance on a |
| | debt for a vehicle repossessed and re-sold by |
| | the institution through auction. |
| OL | Other loans, such as a debt with an institution |
| | or billing party that does not hold collateral. |
| PL | Personal loans, such as a debt not owed to a |
| | family member or friend. This can also include |
| | debts from an institution or billing party that |
| | does not hold collateral. |
| BL | Business loans, such as any debt that is under |
| | a business name or used for business purposes |
| | as long as the business has dissolved. |
| CC | Credit card loans, such as any credit card debt |
| | that is not business related, or does not have |
| | any relationship with the customer's current |
| | financial institution or employer. This can also |
| | include any debt that is not currently in any |
| | form of legal action or garnishment. |
| MB | Medical Bill. Any medical bill from a facility |
| | or doctor that the customer no longer utilizes. |

The system 14 calculates and displays the “Total Balance” of all negotiable debt in a visual field 278 and calculates and displays the “Total Minimum Payments” for all the negotiable debt in a visual field 280.

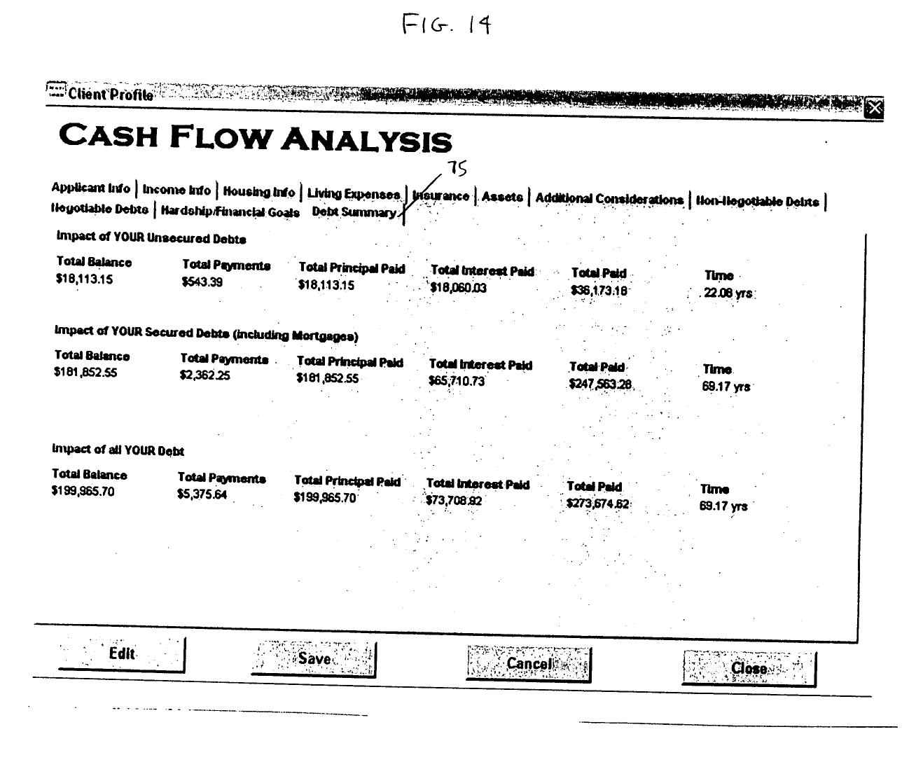

The system 14 utilizes the information entered in the visual fields described in FIGS. 4-13 and provides a debt summary analysis 75 as shown in FIG. 14. The debt summary analysis generally provides the user with an analysis of the interest they will pay on their unsecured debt and their secured debt if they continue to make only the scheduled minimum payments.

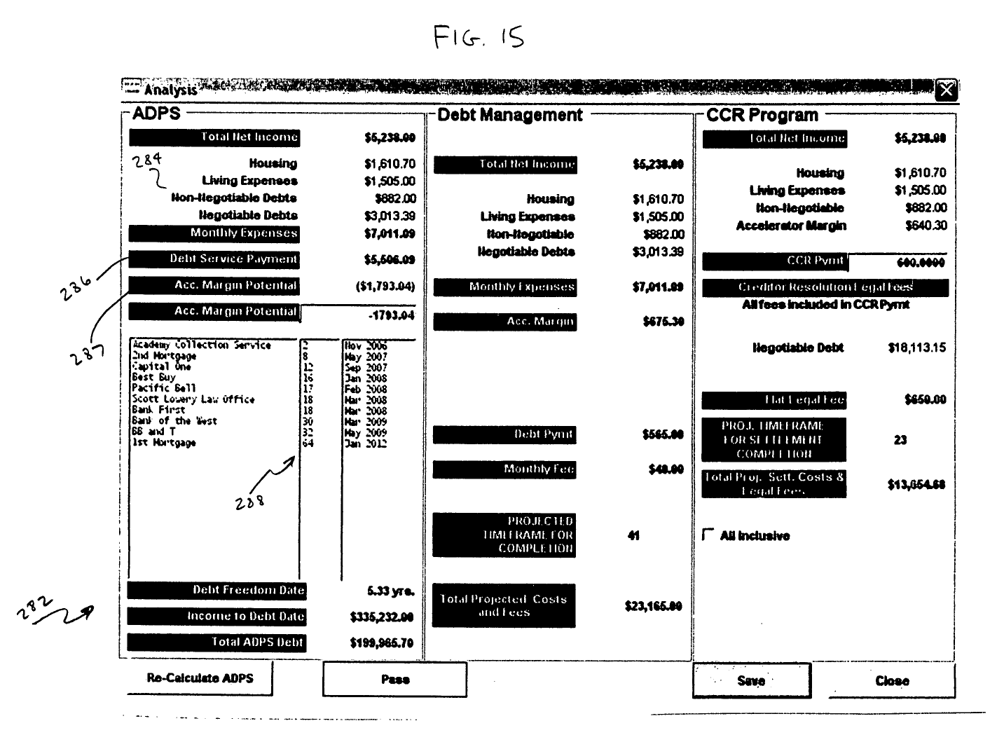

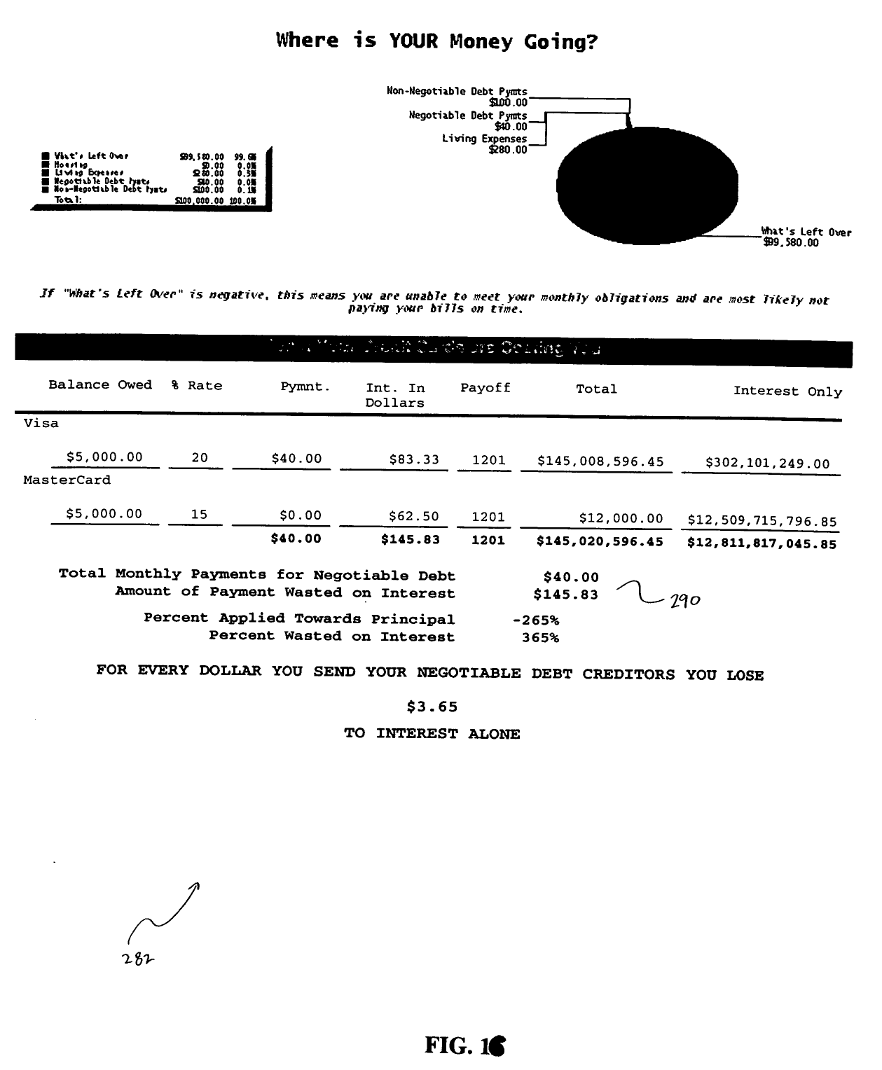

The system 14 also utilizes the information entered in the visual fields described in FIGS. 4-13 and provides a cash position statement 282 for a defined time period 284, as shown in FIGS. 15-16. Based on entered data, the cash position statement 282 provides an assessment of profit and loss by determining whether the income for a defined time period is adequate to pay any and all necessary expenses incurred during the defined time period 284. Preferably, the time period is one month. In addition, the cash position statement 282 provides a debt service payment visual field 286 displaying the amount of debt service payments that need to be paid during the defined time period 284. The system 14 also separately calculates the amounts of debt service payments that are being applied towards principle and interest.

The cash position statement 282 also provides an “Accelerated Margin Potential” visual field 287 displaying the accelerated margin potential. The accelerator margin potential is that portion of income which is set aside to pay additional amounts on expenses and debts. The amount can be to payoff the debt or expense faster or make the debt or expense less in amount. Further, the cash position statement 282 provides timelines 288 for each individual debt to be paid given the information entered into the system 14. It is also contemplated that the cash position statement 282 provides the potential impact of the cash flow on the consumer's credit report given the information entered into the system 14.

Once the cash position is confirmed, the appropriate debt elimination product or service recommendation is made, based in part on the base accelerated margin potential 287. Preferably, during the recommendation phase, disclosure pertaining to the impact of the appropriate product or service recommendation to the consumer is provided. Based on the entered information, and specifically the accelerated margin potential 287, the system 14 can recommend debt consolidation solutions such as Do-It-Yourself products and software, Automated Debt Payment System, restructuring debt with a lending product, consumer credit counseling, debt settlement legal services and bankruptcy services. In addition, supplementary product or service recommendations may be made to avoid any potential negative impact on the customer's credit rating.

Thus, it is contemplated that the system 14 utilize a particular methodology in recommending the appropriate debt consolidation product or service. Based on the entered information, the system 14 determines if the customer can pay off any debt on her own. If the system 14 determines that is not possible, the system 14 calculates a modified accelerator margin potential for the automated base payment system in view of the cost of the automated debt payment system. If modified accelerator margin potential for the automated base payment system is positive, the system 14 recommends that solution. However, if the modified accelerator margin potential for the automated base payment system is negative, the system 14 does not recommend that solution and recommends an alternative solution.

The system 14 calculates a modified accelerator margin potential for the restructuring with a lending product solution in view of the cost of the restructuring of the lending product. The system 14 also determines whether the customer possesses assets, such as equity in a residence, that may allow the customer to restructure the debt in a manner to permit the customer to pay the debt and accelerate debt elimination. If the modified accelerator margin potential for the restructuring with a lending product solution is positive, the system 14 recommends that solution.

If the accelerator margin potential for the restructuring with a lending product solution is negative, the system 14 analyzes whether the customer possesses adequate cash flow to reasonably and successfully subsidize traditional credit counseling services. This is determined by calculating a modified accelerator margin potential for the credit counseling service solution in view of the cost of the credit counseling service. If the modified accelerator margin potential for the credit counseling service solution is positive, the system recommends that solution.

If the modified accelerator margin potential for the credit counseling service solution is negative, the system 14 evaluates whether the customer possesses the ability to fund a debt settlement program. This is determined by calculating a modified accelerator margin potential for the debt settlement service solution in view of the cost of the debt settlement service solution. If the modified accelerator margin potential for the credit counseling service solution is positive, the system recommends that solution.

Finally, if none of the above-identified options are viable, the system 14 determines whether the customer qualifies for bankruptcy under the bankruptcy statutes. Preferably, the system 14 also determines the chapter of bankruptcy for which the customer qualifies.

The process of exhausting a previous option before recommending a subsequent option provides several advantages. For example, utilizing cash flow as a factor regarding the appropriate recommendation encourages full and complete disclosure regarding positive and negative impact in a customer's credit report. Additionally, knowledge that all options are exhausted allows creditors to be more amenable to accepting less money for any debt they have financed. Moreover, when a product or service recommendation is made, the result can benefit the recommending party, such as a bank or financial institution that has a financial interest in the customer's financial interests. Therefore, secondary benefits are provided to the bank or financial institution beyond the traditional collection activity.

An example of determining the appropriate debt consolidation solutions by analyzing a consumer's budget utilizing the present system 14 is described herein. Utilizing the GUI, as described above, applicant info and financial data is provided to the system 14 using the appropriate visual fields. The financial data can include income information, housing information, living expense information, non-negotiable debt and negotiable debt data as described supra.

According to the present example, the following information is entered into the appropriate visual fields:

TABLE 3

| Financial Data | Amount |
|---|---|
| Net Monthly Income | $3,500 |
| Housing Expense | $1,000 |
| Living Expense | $1,200 |
| Non-Negotiable Debt | $900 |
| Negotiable Debt | $1,000 |

Once the applicant information, the above-identified financial data and the above-identified debt data are provided, the system 14 provides a debt impact analysis, as illustrated in FIGS. 15 and 16, based on an analysis of the provided financial data and provided debt data. The debt impact analysis provides a cash position statement, in this example, indicating a negative cash flow of $600 (monthly income of $3500 and monthly expenses of $4100). Once a negative cash position is confirmed, an appropriate debt consolidation product or service recommendation is provided. In the present example, the customer cannot adequately meet all monthly obligations, and as a result has a negative cash flow of $600. Therefore, the appropriate debt consolidation product or service recommendation may be a credit counseling program. However, if the system 14 determines that credit counseling only decreases the negotiable debt monthly obligation to $750, the customer would still have a negative cash flow of $350. Thus, the system 14 may determine that the credit counseling program does not adequately provide debt consolidation. Accordingly, the system 14 may recommend a debt settlement solution that would require the customer to pay $400 of negotiable debt a month, instead of $1,000 of negotiable debt a month. In this manner, the customer cash position is zero and the customer can adequately pay the debt.

In an alternative example, the following information is entered into the appropriate visual field:

TABLE 4

| Financial Data | Amount |
|---|---|
| Net Monthly Income | $4,500 |
| Housing Expense | $1,000 |
| Living Expense | $1,200 |
| Non-Negotiable Debt | $900 |
| Negotiable Debt | $1,000 |

In this example, the customer has a positive cash flow of $400 (monthly incompe of $4500 and monthly expenses of $4100) and consequently has adequate cash to meet all monthly obligations. Therefore, neither credit counseling nor debt settlement solutions would be recommended. Rather, a Do-It-Yourself program or a Automated Debt Payment System will be recommended to consolidate and eliminate the debt.

Referring now to FIG. 16, the present invention further provides a system and method whereby a user can initiate a cash flow analysis. The cash flow analysis provides a graphical user interface comprising visual fields illustrating the customer user's “cash flow”, which will be understood by one of skill in the art to include information regarding the payees to whom the user's money is being transferred and the sources of income contributing to the user's net worth. The cash flow analysis can be used by the present system and method to determine a monthly or annual net output, wherein the net output is the measure of money that is being transferred from the user's net worth to the parties with whom the user has a debt. The cash flow analysis can also be used to determine a monthly or annual net input, wherein the net input is the measure of money that is being transferred to the user's net worth. A plurality of debt management solutions and proposals can then be analyzed, wherein the analysis comprises determining which of the plurality of solutions minimizes the net output. The proposal having the highest effect of minimizing the net output can then be recommended to the user as a debt management solution.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. An executable system for managing debt and residing in a memory, the system comprising:
logic for receiving financial information, the financial information comprising at least debt information;
logic for generating a debt impact analysis based on the received financial information;
logic for generating a first debt management proposal by analyzing a first debt management solution impact on the received financial information;
logic for generating a second debt management proposal by analyzing a second debt management solution impact on the received financial information;
logic for comparing the first and second debt management proposals; and,
logic for generating a user interface comprising one of the first and second debt management proposals based on the comparison of the first and second debt management proposals.

2. The system of claim 1, wherein the debt impact analysis includes a base accelerator margin potential value.

3. The system of claim 2, wherein at least one of the first and second debt management proposals is based on the base accelerator margin potential value.

4. The system of claim 1, wherein the financial information comprises at least one of income information, housing information, living expense information, insurance information, liquid asset information, retirement asset information and hardship information.

5. The system of claim 1, further comprising logic for receiving applicant information.

6. The system of claim 1, wherein the debt information includes at least one of negotiable debt information and non-negotiable debt information.

7. The system of claim 1, wherein at least one of the first and second debt management proposal includes at least one of a consumer software product, an automated debt payment system, a lending product for restructuring debt, a consumer credit counseling program, a debt settlement legal service and a bankruptcy service.

8. The system of claim 1, wherein the debt impact analysis includes at least one of a cash position statement, an amount of debt service payments applied to principal and interest, a timeline for settling an individual debt and a statement of potential impact of cash flow on a credit report.

9. A system for managing debt, the system residing in a memory and comprising:
a first code segment for receiving financial information, the financial information comprising at least debt information;
a second code segment for generating a debt impact analysis based on the received financial information;
a third code segment for generating a base accelerator margin potential value based on the received financial information; and,
a fourth code segment for comparing the base accelerator margin potential value with an accelerator base margin value for a first debt management solution; and,
a fifth code segment for recommending the first debt management solution if the base accelerator margin value is greater than the accelerator base margin value for the first debt management solution.

10. The system of claim 9 further comprising:
a sixth code segment for comparing the base accelerator margin potential value with an accelerator base margin value for a second debt management solution if the base accelerator margin value is less than the accelerator base margin value for the first debt management solution; and
a seventh code segment for recommending the second debt management solution if the base accelerator margin value is greater than the accelerator base margin value for the second debt management solution.

11. The system of claim 9, wherein the financial information comprises at least one of income information, housing information, living expense information, insurance information, liquid asset information, retirement asset information and hardship information.

12. The system of claim 9, further comprising:
a sixth code segment for receiving applicant information.

13. The system of claim 9, wherein the debt information includes at least one of negotiable debt information and non-negotiable debt information.

14. The system of claim 9, wherein the first debt management solution includes at least one of a consumer software product, an automated debt payment system, a lending product for restructuring debt, a consumer credit counseling program, a debt settlement legal service and a bankruptcy service.

15. The system of claim 9, wherein the debt impact analysis includes at least one of a cash position statement, an amount of debt service payments applied to principal and interest, a timeline for settling an individual debt and a statement of potential impact of cash flow on a credit report.

16. A method for recommending a debt management solution, the method comprising the steps of:
receiving financial information from a user via a computer-generated user interface, wherein the financial information comprises at least debt information;
generating a base accelerator margin value based on the received financial information;
analyzing a first debt management solution by comparing the base accelerator margin value with a first solution margin value corresponding to the first debt management solution;
analyzing a second debt management solution by comparing the base accelerator margin value with a second solution margin value corresponding to the second debt management solution; and,
selecting a selected debt management solution from among the first and second debt management solutions based on the first and second solution margin values; and,
generating a user interface comprising the selected debt management solution.

17. The method of claim 16, wherein the financial information comprises at least one of income information, housing information, living expense information, insurance information, liquid asset information, retirement asset information and hardship information.

18. The system of claim 16, wherein the debt information includes at least one of negotiable debt information and non-negotiable debt information.

19. The system of claim 16, the first debt management solution includes at least one of a consumer software product, an automated debt payment system, a lending product for restructuring debt, a consumer credit counseling program, a debt settlement legal service and a bankruptcy service.

20. The method of claim 16, further comprising the step of:
generating a debt impact analysis, wherein the debt impact analysis includes at least one of a cash position statement, an amount of debt service payments applied to principal and interest, a timeline for settling an individual debt and a statement of potential impact of cash flow on a credit report.
